(19) United States
(12) Patent Application Publication
(10) Pub. No.: US 2015/0200430 A1
(43) Pub. Date: Jul. 16, 2015

(54) VEHICLE HAVING A BATTERY ARRANGEMENT

(71) Applicant: AUDI AG, INGOLSTADT (DE)

(72) Inventors: Christian Allmann, Ingolstadt (DE); Martin Schüssler, Kösching (DE)

(73) Assignee: AUDI AG, 85045 Ingolstadt (DE)

(21) Appl. No.: 14/408,843

(22) PCT Filed: May 29, 2013
(86) PCT No.: PCT/EP2013/001588

§ 371 Date: Dec. 17, 2014

(30) Foreign Application Priority Data
Jun. 20, 2012 (DE) 10 2012 012 294.2

(51) Int. Cl. H01M 10/625; B60L 11/18

(52) U.S. Cl. CPC H01M 10/625; H01M 10/6551; B60L 11/1877; H01M 2220/20

(57) ABSTRACT

A vehicle has at least one battery arrangement, which includes at least one battery unit and a cooling device for dissipating heat from the at least one battery unit The cooling device is arranged in a load path of the vehicle in such a way that the cooling device can be deformed in the event of an application of force to the vehicle caused by an accident. For this purpose, the cooling device includes a plurality of cooling ribs around which cooling air flows during cooling operation of the cooling device.

The invention relates to a vehicle having at least one battery arrangement which includes at least one battery unit and a cooling device for removing heat from the at least one battery unit. The cooling device is hereby arranged in a load path of the vehicle such as to be deformable in the event the vehicle is exposed to a force caused by an accident.

DE 10 2008 024 291 A1 describes a passenger car with a sub-floor which has cross members and side rails as well as a longitudinal member in a passenger cell area. In areas surrounded by these carriers a battery may be arranged to close the body. Thus, the battery assumes the function of a body closure and load absorption. For cooling purposes, the battery may have on its outer surface a cooling body with cooling ribs.

DE 10 2009 006 990 A1 describes a motor vehicle with a vehicle tunnel in which a battery module is arranged. A mounting plate assumes hereby the function of a lower housing part of the battery module, with the mounting plate extending in transverse direction of the vehicle tunnel up to inner longitudinal members. The mounting plate thus prevents a reduction of the tunnel cross section and thus a deformation of the battery module in the event of a side impact. A U-shaped tunnel part connected with the two longitudinal members completes the vehicle tunnel. Cooling ribs are arranged on the outer surfaces of the mounting plate.

KR 100210949 B1 describes a battery box for an electric vehicle to receive a plurality of battery units. Cooling ribs extend from each side wall of the battery box and have different lengths. A respective part of the four side walls of the battery box is furthermore moreover free of cooling ribs. When exposed to a force caused by an accident, the cooling ribs break since a notch is provided in the vicinity of each side wall of the battery box to thereby reduce a thickness of each rib. This deformation of the cooling ribs prevents a deformation of the side wall of the battery box.

DE 10 2010 033 806 A1 describes a battery pack with a plurality of battery modules, with the individual battery modules in turn including a plurality of cylindrical battery cells. Deformation elements are arranged between two adjacent battery modules. When the battery pack is exposed to a force caused by an accident, the deformation elements deform, with the battery modules moving relative to one another. A packing unit may hereby include a battery module to which the deformation element is secured. The deformation element can be configured in particular as cooling channel through which a cooling fluid or cooling air flows.

Furthermore, DE 10 2009 030 016 A1 describes an apparatus for power supply of a motor vehicle to accommodate in a cooler block battery modules having a plurality of battery cells. The cooler block includes a structure through which a coolant or refrigerant flows. A so-called crash plate is further arranged in the cooler block and has a lateral edge provided with projections. When the apparatus is exposed to a force caused by an accident, the crash plate absorbs the force acting on the apparatus and directs it around the battery modules which accommodate the battery cells.

It is hereby considered disadvantageous that the described cooling devices are relatively complicated.

Object of the present invention is therefore to provide a vehicle with a battery arrangement of the afore-mentioned type, in which the cooling device is particularly simple in structure and allows a particularly efficient removal of heat.

This object is achieved by a vehicle having the features of patent claim 1. Advantageous embodiments with useful refinements of the invention are set forth in the dependent claims.

In the vehicle according to the invention, the cooling device has a plurality of cooling ribs across which cooling air flows in a cooling mode of the cooling device. This is based on the recognition that it is useful for an air-cooled battery arrangement to use the cooling ribs as deformation elements. Thus, the cooling ribs can dissipate kinetic energy in the event of a crash as a result of their deformation. The provision of the cooling ribs also enables a particularly simple construction of the cooling device. Furthermore, as cooling air sweeps also around the free ends of the cooling ribs, a particularly efficient heat removal from the battery unit is made possible, when the cooling ribs are exposed in the cooling mode to the cooling air.

By utilizing the cooling air as cooling medium instead of a cooling liquid, there is also no need for providing conduits which could pose a problem when leaking in the event of an accident.

In addition, provision of separate deformation elements in the battery arrangement can be omitted. Rather, the cooling ribs, already provided to remove heat of the battery unit, are used at the same time to dissipate impact energy as they deform, when exposed to a force caused by an accident. The cooling ribs are therefore part of the battery arrangement; however, they are designed not only in terms of cooling, but also in terms of their capability to convert impact energy into deformation energy and thus to be able to dissipate it.

In the invention, at least two battery arrangements are coupled to one another such as to form a rigid block, when exposed to a force caused by an accident, and to not change their position relative to one another. In this case, crash energy is almost exclusively dissipated by the deformation of the cooling ribs. There is no need to shape the battery arrangements to permit a relative movement thereof. In this way, the potential of the cooling ribs to dissipate crash energy can be exploited to an especially large extent.

According to an advantageous embodiment of the invention, a longitudinal extension direction perpendicular to walls of a housing unit of the at least one battery of at least one of the cooling ribs coincides with the direction of the load path. In this case, this at least one cooling rib is able to absorb impact energy particularly well.

It has also been shown as advantageous, when the at least one battery unit is arranged in a housing, with the cooling ribs being formed in one piece with a wall of the housing. This enables a particularly good heat transfer from the wall of the housing onto the cooling ribs. This is beneficial for a most efficient cooling of the battery unit.

The at least one battery unit can be configured as a battery cell. Then, the cooling ribs are associated to the individual battery cells to dissipate impact energy in the event of a crash. This allows an especially flexible placement of the battery arrangements in the vehicle in terms of the expected energy dissipation in the event of a crash.

As an alternative, the at least one battery unit can have a plurality of battery cells. Such a battery unit may also be referred to as a battery module, in which the individual battery cells are accommodated. This makes it possible to arrange the battery cells in the battery unit in a compact way and then to place the battery arrangement in a suitable manner in the load path of the vehicle.

It has further been shown as advantageous, when properties of the cooling ribs vary across the at least one battery arrangement. This may involve in particular a configuration of the cooling ribs and/or a wall thickness of the cooling ribs and/or orientation of the cooling ribs in such a way as to be especially well suited to remove heat or warmth or to dissipate crash energy in dependence on the location of their disposition in the vehicle.

In this case, provision may be made to vary a number of cooling ribs per unit area and/or a material of the cooling ribs not only in terms of the expected cooling capacity, i.e. to consider, for example, the heat transfer coefficient of the cooling ribs, but also to consider in the design the expected energy absorption in the event of a crash.

For example, the cooling ribs can be made of particularly great thickness in a region of the vehicle, which undergoes a particularly intense deformation, i.e. in a so-called crash zone, when exposed to a force caused by an accident. This also results in the capability to remove much heat via these cooling ribs. The provision of comparably thick cooling ribs may, however, also be advantageous in a region of the vehicle, in which especially much heat should be removed.

The at least one battery arrangement can be round in cross section. This applies in particular when the battery unit is formed as a round single cell, i.e. a round cell is involved.

For storing electrical energy for a drive aggregate configured to propel the vehicle, prismatic cells may, however, also be used, i.e. those having a polygonal, normally rectangular, cross section. Battery arrangements with one or more of such prismatic battery cells may also include the cooling ribs to remove heat from the battery unit and to dissipate impact energy in the event of a crash. Battery arrangements polygonal in cross section may be configured in particular hexagonal in cross section.

The provision of battery arrangements that are polygonal in cross section enables a targeted provision of the cooling ribs on the respective outer sides of the battery arrangement such that the cooling ribs are deformed, when exposed to a force caused by an accident and thus to dissipate impact energy.

Finally, it has been shown to be advantageous, when a plurality of battery arrangements that are polygonal in cross section are arranged substantially without gaps in a compact manner in the vehicle. As a result, an assembly comprised of the battery arrangements requires comparably little installation space.

The afore-mentioned features and feature combinations in the description as well as the individual features and feature combinations referred to hereinafter in the figure description and/or shown in the figures can be used not only in the respectively referred-to combination, but also in other combinations or alone, without departing the scope of the invention.

Further advantages, features and details of the invention will become apparent from the claims, the following description of preferred embodiments and with reference to the drawings, in which like elements or functionally corresponding elements are provided with identical reference numerals. It is hereby shown in:

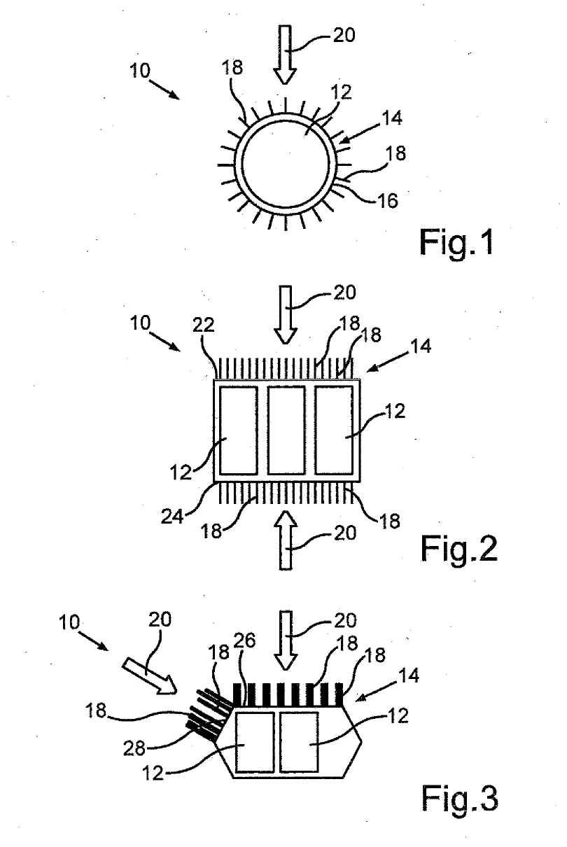

FIG. 1 schematically a battery arrangement with a battery unit in the form of a round battery cell, with a cylindrical housing of the battery cell being provided with cooling ribs;

FIG. 2 a battery arrangement in the form of a battery module having a plurality of individual battery cells, with cooling ribs being arranged on a housing of the battery module;

FIG. 3 a battery module with a hexagonal housing shape, with cooling ribs being arranged on respective sides of a housing of the battery module and varying in their number per unit area and their thickness;

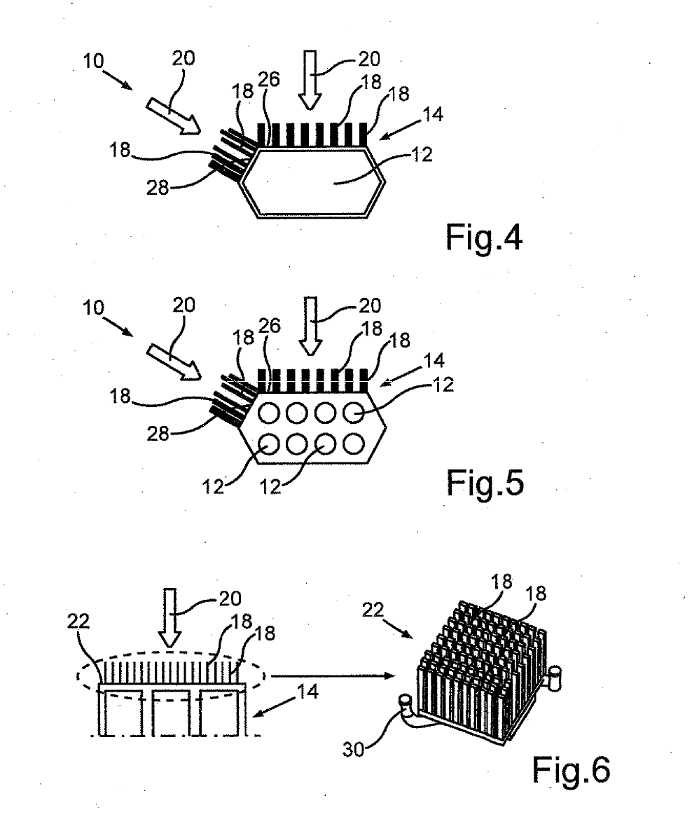

FIG. 4 a battery module with a housing according to FIG. 3, with the battery unit of the battery module being configured as a single battery cell;

FIG. 5 the battery module according to FIG. 3 with round cells in the hexagonal housing;

FIG. 6 a detail of the battery arrangement according to FIG. 2, with a housing wall provided with the cooling ribs additionally shown in perspective;

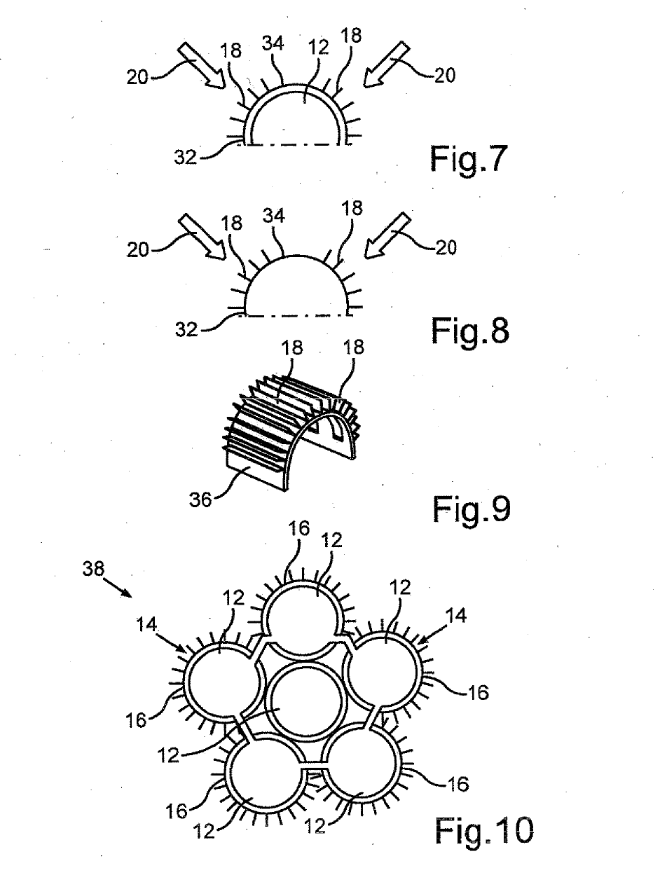

FIG. 7 a detail of a battery arrangement with a housing wall that is semicircular in cross section and has cooling ribs pointing in different directions;

FIG. 8 a side view of the housing wall according to FIG. 7;

FIG. 9 a perspective view of a housing wall that is semicircular in cross section with cooling ribs;

FIG. 10 an assembly of battery arrangements with battery cells which are designed as round cells, with walls of the housing of the respective battery arrangements having areas provided with the cooling ribs;

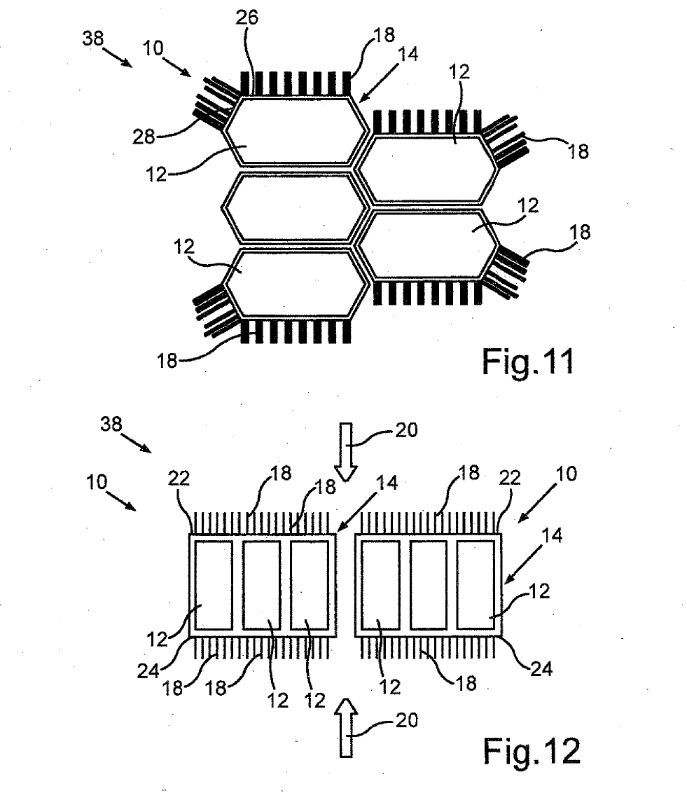

FIG. 11 another assembly of hexagonal battery modules configured according to FIG. 4; and

FIG. 12 another assembly of battery modules configured according to FIG. 2.

FIG. 1 shows a battery arrangement 10 which includes a single battery cell as a battery unit 12. Such a battery cell 12 may, for example, be formed as a lithium-ion battery cell to provide electric energy for an electric drive motor of a vehicle. The battery cell 12 is enclosed by a housing 14 which like the battery cell 12 is formed round in cross section. Formed in one piece with a wall 16 of the housing 14 are a plurality of cooling ribs 18 which jut out in radial direction from an outer circumference of the wall 16.

The housing 14 with the cooling ribs 18 serves as a cooling device for the battery cell 12. This cooling device is arranged in a load path of the vehicle such that the cooling ribs 18 deform, when the vehicle is exposed to a force caused by an accident. The load path is illustrated in FIG. 1 by arrow 20.

Thus, the cooling ribs 18 of the battery arrangement 10 according to FIG. 1 are specifically used as deformation elements which not only provide air cooling of the battery cell 12 but also dissipate impact energy in the event of an accident of the vehicle. In the cooling mode, cooling air sweeps around the cooling ribs 18, whereby this can be effected by the slip stream. In addition or as an alternative, a fan may be provided to expose the cooling ribs 18 to the cooling air.

While the cooling ribs 18 are arranged in the battery arrangement 10 according to FIG. 1 circumferentially about the wall 16 formed as circular-cylindrical cylinder casing, the housing 14 of the battery arrangement 10 shown in FIG. 2 is rectangular in cross section, and not all outer sides of the housing have cooling ribs 18. Furthermore, the battery unit is configured here as a battery module which has a plurality of single battery cells 12, wherein three battery cells 12 are shown here only schematically and by way of example as being disposed in the housing 14.

The cooling ribs 18 are arranged at respective end walls 22, 24 of the housing 14. The respective longitudinal extension direction of the cooling ribs 18 coincides hereby with the direction of a load path in the vehicle, as indicated by the arrows 20. The cooling ribs 18 are formed also in this battery arrangement 10 in one piece with the walls 22, 24.

In the battery module according to FIG. 2, the battery cells 2 arranged within the housing 14, which is rectangular in cross section, are also rectangular in cross section. Thus, so-called prismatic battery cells 12 are involved. These are also referred to as flat cells.

In the battery arrangement 10 shown in FIG. 3, the housing 14 is configured hexagonal in cross section, with an upper or end wall 26 having a greater length than a laterally adjoining further wall 28. The cooling ribs 18 formed in one piece with the upper wall 26 have same wall thicknesses, and their number per unit area is also uniform in the region of the wall 26.

Conversely, the cooling ribs 18 formed in one piece with the further wall 28 have a thickness, number per unit area and length which vary across the battery arrangement 10. In this case, the afore-described properties of the cooling ribs 18 are both fixed in terms of the expected cooling rate and in terms of the expected energy dissipation in the event of a crash. The thicker cooling ribs 18 can, in fact, dissipate more crash energy and remove more heat at the same time.

In the battery arrangement 10 shown in FIG. 3, the housing 14 encloses a plurality of individual battery cells 12. In the battery arrangement 10 shown in FIG. 4, the housing 14 is configured in a manner as shown in FIG. 3, but accommodates therein only a single battery cell 12 that is also hexagonal in cross section. Also in this case, the cooling ribs 18 are shown schematically on only two of the walls 26, 28 of the housing 14, although also the remaining walls of the housing 14 may be provided with cooling ribs 18 especially in terms of their number, shape, material selection and the like, and adapted to the respective load path.

Also, in the battery arrangement 10 shown in FIG. 5, the housing 14 is configured as shown in FIG. 3. However, the housing 14 accommodates therein a plurality of battery cells 12 configured, for example, as round cells.

FIG. 6 shows the upper end wall 22 of the housing 14 of the battery arrangement 10 according to FIG. 2 on an enlarged scale, with this end wall 22 being also shown by way of a perspective view. This perspective view in particular shows that the individual cooling ribs 18 can be formed not only as walls, but also as pins or tines. The end wall 22 may be connected to the remaining walls of the housing 14 by fasteners, such as bolts 30 as shown by way of example. The connection may, however, be realized by welding and/or gluing and/or by a form fit.

FIG. 7 shows a detail of a battery cell 12 configured as round cell and arranged in a housing having a wall 32 which is semi-circular in cross section. There is a region 34 of the wall 32 which is not provided with cooling ribs 18, since there is no expected exposure in this region 34 to a force in the event of an accident of the vehicle. The cooling ribs 18 formed in one piece with the remaining regions of the wall 32 are, however, located in the area of respective load paths.

FIG. 8 shows the wall 32 without the battery cell 12. FIG. 9 shows a further wall 36, which is semi-circular in cross section, for a round cell or a round battery module, with the individual cooling ribs 18 being formed as walls which are evenly spaced apart from one another in circumferential direction and protrude radially from the wall 36.

As is apparent from FIGS. 1 to 9, the cooling ribs 18 can be used for battery cells 12 or several battery modules comprised of several battery cells 12 of any geometry.

In an assembly 38 of battery arrangements 10 as shown in FIG. 10, the individual battery cells 12 provided with the respective housing 14 are formed as round cells. The walls 16 of the housing 14 of adjacent battery cells 12 touch one another in this assembly 38. As a result, these battery arrangements 10 form a substantially rigid block, when exposed to a force caused by an accident.

Only the walls 16 of the housing 14, which form in the assembly 38 outer sides thereof, are provided here with the cooling ribs 18. Thus, heat can be easily removed via these cooling ribs 18, when cooling air flows around the latter. At the same time, crash energy can be dissipated by the deformation of the cooling ribs 18 when exposed to a force caused by an accident. In this case, the individual battery arrangements 10 do not substantially change their position relative to each other; they are at most slightly shifted relative to each other within the assembly 38.

Also in the assembly 38 of battery arrangements 10 shown in FIG. 11, the housing 14 of the individual battery cells 12 are placed adjacent to each other. In the assembly 38, the individual battery arrangements 10 do also not shift relative to each other, when exposed to a force caused by an accident. Also in this case, cooling ribs 18 are arranged only on those walls 26, 28 of the housing 14 that form outer sides of the assembly 38.

The housings 14 are hereby—like as shown in FIGS. 3 to 5—formed hexagonal in cross section, with the housing 14 (as shown in FIG. 11 by way of example) being able to enclose individual battery cells 12 or a plurality of battery cells. In the assembly 38, the individual battery arrangements 10 are tightly packed substantially without gaps so that they can be accommodated in a particularly space-saving manner in the vehicle.

The assembly 38 shown in FIG. 12 has two battery arrangements 10 that are rectangular in cross section and arranged side-by-side, with the individual battery arrangements 10 corresponding to the battery arrangement 10 shown in FIG. 2. In this assembly 38, only the walls 22, 24 that form the end faces of the individual battery arrangements 10 are provided with the cooling ribs 18. An alignment of the cooling ribs 18 coincides hereby with the direction of the load path in the vehicle, as indicated by arrows 20.

1.-7. (canceled)

8. A vehicle, comprising:
at least two battery arrangements, each battery arrangement including at least one battery unit and a cooling device adapted to dissipate heat from the at least one battery unit and arranged in a load path of the vehicle such as to be deformable when the vehicle is exposed to a force caused by an accident, said cooling device including a plurality of cooling ribs around which cooling air flows in a cooling mode of the cooling device,
wherein the at least two battery arrangements are coupled to one another such as to form a rigid block absent any change in their position relative to one another, when exposed to the force caused by the accident.

9. The vehicle of claim 8, wherein the at least one battery unit has a housing, at least one of the cooling ribs having in perpendicular relation to a wall of the housing a longitudinal extension direction which coincides with a direction of the load path.

10. The vehicle of claim 8, further comprising a housing, said at least one battery unit being arranged in the housing, with the cooling ribs being formed in one piece with a wall of the housing.

11. The vehicle of claim 8, wherein the at least one battery unit is formed as a battery cell or a plurality of battery cells.

12. The vehicle of claim 8, wherein the battery assembly is configured to vary a member selected from the group consisting of shape of the cooling ribs, number of the cooling ribs per unit area, wall thickness of the cooling ribs, alignment of the cooling ribs, and material of the cooling ribs, across the battery assembly.

13. The vehicle of claim 8, wherein the battery arrangement is round in cross section.

14. The vehicle of claim 8, wherein the battery arrangement is polygonal in cross section.

15. The vehicle of claim 14, wherein the battery arrangement is rectangular or hexagonal in cross section.

16. The vehicle of claim 8, further comprising a plurality of said battery arrangements placed in tight formation essentially without gaps in the vehicle.
